(19) United States
(12) Patent Application Publication
(10) Pub. No.: US 2009/0090795 A1
(43) Pub. Date: Apr. 9, 2009

(54) SURFACE PAINTING SYSTEM

(76) Inventor: Charles D. Ray, Santa Barbara, CA (US)

Correspondence Address: DICKE, BILLIG & CZAJA, FIFTH STREET TOWERS, 100 SOUTH FIFTH STREET, SUITE 2250, MINNEAPOLIS, MN, 55402, US

(21) Appl. No.: 11/867,420

(22) Filed: Oct. 4, 2007

(51) Int. Cl. B05B 5/00

(52) U.S. Cl. 239/703; 427/427.1

(57) ABSTRACT

Systems and methods for painting a surface are disclosed. The method includes securing a track relative to a surface to be painted. A traveling control unit is mounted to the track. The spray head is suspended from the traveling control unit and in front of the surface to be painted. The spray head is moved relative to the surface by moving the traveling control unit along the track to move the spray head along a first painting axis and moving the spray head relative to the control unit along a second painting axis. A painting plan for a design to be painted is executed by emitting a spray of paint from the spray head at various coordinates. An image of the surface can be scanned and overlayed with a virtual representation of the design for evaluation prior to painting.

### FIELD OF THE DISCLOSURE

Aspects of the present invention relate to a system for painting surfaces, and more particularly automated systems for painting large surfaces such as billboards, exteriors or interiors of large buildings, or other large structures. The systems can have applications for painting large murals under combined manual and automatic computer control, including precise systems for painting murals on the surfaces of large buildings, indoors or outdoors.

### BACKGROUND OF THE DISCLOSURE

Desirable, decorative and artistic outdoor murals on relatively large structures such as buildings are generally painted by hand using brushes or sprayers. They often convey socially responsible, patriotic, political, product advertising or purely artistic themes. They are often highly realistic, eye-tricking and inviting. All such murals require a great number of man-hours of individual or multiple artists. The painting of very large pictures requires unusual skills and preparation. The transfer of sketches or outlines onto large surfaces is often accomplished using image projection followed by extensive manual tracing worked from fixed or movable platforms or cranes placed near the building to be painted. This is further complicated by commonly encountered surface irregularities, like stone or brick, and the interposition of open spaces like windows or door portals, gaps in the construction or protruding obstructions. Further difficulties arise from changes in wind and weather. The application of large quantities of paint and other media pose problems in logistics and the handling of massive liquid or gel filled containers. While large outdoor murals may be highly desirable, particularly in urban renewal projects, the time and expense involved are generally prohibitive.

Large outdoor advertising signs often utilize a flexible medium or fabric, which is then stretched over a suitable billboard structure. This method is generally not adaptable to large and/or irregular surfaces, such as the walls of buildings, particularly those having such irregularities as rough surfaces, windows, doors or unusually shaped walls. All together it is the substantial expense and limited availability of suitable talent that restrict the wider application of both indoor and outdoor mural art.

With the above Background in mind, improvements to, and advancement in mural painting would be welcomed by numerous public and private institutions. Manufacturers and service providers as well as urban developers in both large and small communities will also welcome these advancements. Further, a large outdoor mural that is simpler to create is also simpler to change as desired or as required according to taste, purpose and need.

### SUMMARY

Some embodiments of the present disclosure relate to a surface painting system including a first track, a first traveling control unit, a spray head carriage, a spray head, and an actuator. The first track is adapted to be secured relative to a surface to be painted and extend along the surface to be painted. The first traveling control unit is mounted on the first track and is adapted to traverse the track. The spray head carriage is maintained by the first traveling control unit with a connector extending between the first traveling control unit and the spray head carriage. The spray head is housed by the spray head carriage. The spray head is adapted to emit a spray of paint for painting the surface to be painted. The actuator is adapted for extending or retracting the connector to move the spray head carriage toward and away from the first traveling control unit.

Other embodiments of the present disclosure relate to a method of painting a surface. The method includes securing a first track relative to a surface to be painted. A first traveling control unit is mounted to the first track. The spray head is suspended from the first traveling control unit and in front of the surface to be painted. The spray head is moved relative to the surface to be painted by moving the first traveling control unit along the first track to move the spray head along a first painting access and moving the spray head relative to the first control unit along a second painting axis. A painting plan for a design to be painted is executed by emitting a spray of paint from the spray head at various coordinates onto the surface to be painted. In some embodiments, an image surface to be painted is electronically captured or created (e.g., scanned), and a virtual representation of the intended design is electronically overlayed to the surface image in a manner representing the intended application of the design to the surface. Based upon an evaluation of the virtual representation of the design to the surface, alterations to the design and/or expected positioning of the painted design along the surface can be implemented prior to actual painting.

While aspects of embodiments of the present disclosure have been described above, other related components, systems, and methods are also disclosed and provide additional advantages.

### BRIEF DESCRIPTION OF THE DRAWINGS

Embodiments of the invention are better understood with reference to the following drawings. The elements of the drawings are not necessarily to scale relative to each other. Like reference numerals designate corresponding similar parts.

FIG. 1 shows a spray head, according to principles of the present disclosure.

FIG. 2 illustrates a spray head container for holding one or more spray heads, according to principles of the present disclosure.

FIG. 3 illustrates a locking mechanism for removal and maintenance of spray heads, according to principles of the present disclosure.

FIG. 4 illustrates a surface painting system including a first traveling control unit, according to principles of the present disclosure.

FIG. 5 shows a cross-section of the rail of FIG. 4, according to principles of the present disclosure.

FIG. 6 shows an end view of a dual tape structure, according to principles of the present disclosure.

FIG. 7 is a cross-section of combined vertical pulling and power cable, according to principles of the present disclosure.

FIG. 8 illustrates a surface painting system including a first traveling control unit and a second traveling control unit, according to principles of the present disclosure.

FIG. 9 is a diagram of a housing, also described as a “mother house” or parking garage, according to principles of the present disclosure.

FIG. 10 illustrates a multi tubing roller pump for replenishing paint reservoirs, according to principles of the present disclosure.

FIG. 11 shows a concave portion of a valve, according to principles of the present disclosure.

FIG. 12 is a cross sectional view of a spray head carriage having three spray head containers mounted so as to have a confluent paint focus, according to principles of the present disclosure.

### DETAILED DESCRIPTION

In the following Detailed Description, reference is made to the accompanying drawings that form a part hereof, and in which is shown by way of illustration specific embodiments in which the disclosure may be practiced. In this regard, directional terminology, such as “top,” “bottom,” “front,” “back,” “leading,” “trailing,” etc., is used with reference to the orientation of the Figure(s) being described. Because components of embodiments of the present disclosure can be positioned in a number of different orientations, the directional terminology is used for purposes of illustration and is in no way limiting. It is to be understood that other embodiments may be utilized and structural or logical changes may be made without departing from the scope of the present disclosure. The following detailed description, therefore, is not to be taken in a limiting sense, and the scope of the present disclosure is defined by the appended claims.

In general terms, embodiments of the present disclosure provide means and methods for painting murals or other relatively large paintings on surfaces such as ceilings, walls, other structural surfaces. In one embodiment, a mural painting system includes one or more tracks or support rails that are permanently, semi-permanently, or temporarily secured relative to a surface to be painted, with the track or tracks serving as a guiding and supporting means for portions of the system. In one embodiment, the track is optionally a toothed rail mounted essentially horizontally or at a desired angle along an edge of the surface to be painted. The track is also optionally mounted substantially vertically as desired. A traveling control unit rides the track. In turn, a vertically controlled spray head carriage is attached and suspended from the traveling control unit such that a spray head mounted to the spray head carriage is movable horizontally and vertically under precise control. Although in one embodiment the horizontal traveling control unit moves laterally, or horizontally, with the spray head carriage moving vertically, it should be understood that other embodiments portion of a include the traveling control unit being adapted to move substantially vertically, with the spray head carriage, in turn, moving substantially horizontally.

Regardless, the traveling control unit is optionally computer controlled and servo-motorized along an X-axis, while the spray head carriage is also optionally computer controlled and servo-motorized along the vertical or Y-axis position. In this manner, an X-Y position the spray head carriage is able to be relatively precisely controlled, for example within about ±2 mm.

For smaller murals, the spray head carriage optionally hangs, or is otherwise connected to the traveling control unit using a pair of flexible tapes, for example tapes somewhat similar to extendable carpenter's measuring tapes. The tapes are placed back to back and are conjoined together at intervals by a frictional means that removably, but firmly bind them together in a substantially rigid configuration. Each of the two tapes is rolled on and off a drum mounted on the traveling control unit. In particular, the spray head carriage is secured to the two tapes such that a length of combined tapes below the traveling control unit determines the vertical position of the spray head carriage. By temporarily bonding the tapes together and facing them in reverse positions, the tapes are stiffened and less prone to bending; yet when separated, the tapes can be bent and rolled up into their respective spring-return drums. The drums are also optionally servo-motor controlled allowing relatively precise positioning of the spray head carriage.

For very large murals, for example murals extending beyond 25 feet in width or height, a suspending-pulling cable means is optionally used to accomplish more precise vertical positioning control of the spray head carriage. In this case, two tracks are optionally used, one above and one below a portion of the surface to be painted, for example. Upper and lower traveling control units traverse the respective tracks and are optionally synchronized. The traveling control units include suitable drums or other means for vertically actuating the suspending-pulling cable means or other connector, which in turn, controls the vertical position of the spray head carriage.

Additionally, attached to one track is a housing acting as a caging “home port” or “parking garage” for one or both of the spray head carriage and the traveling control unit. In this home port, any or all of spray head initial set-up, testing, cleaning and subsequent correction of problems and replenishing of paint are optionally performed. Additionally, the home port optionally acts as place for storing various components of the system. The X-axis distance through which the traveling control unit or units are adapted to be actuated can be many yards long, for example at least about 10 yards. The Y-axis distance through which the spray head carriage travels can be similarly large.

The vertical or Y-axis of the system is determined by the height of the suspended spray head carriage hanging on the traveling control unit. In one embodiment, the Y-axis position of the spray head carriage is controlled by a servo-motor system that continuously detects and controls a distance of the spray head carriage relative to fixed points on the painting surface and the home port. Both fixed and moving laser and infrared measuring means utilizing feedback control circuits are optionally used to provide information relating to spray head carriage location.

For reference, as used herein, Z-axis measurements represent a distance between the spray head carriage, or a spray head or spray heads maintained therein, and the painting surface. The Z-axis distance is optionally set by a rolling spacer that rests against the painting surface in a position set by a linear actuator monitored by a suitable proximity detector. Monitoring of Z-axis measurements facilitates painting irregular or rough surfaces and also is optionally used to control paint jet or paint spray diameter where paint contacts the painting surface.

In some embodiments, a controller such as a computer system or systems or other microprocessing unit or units optionally precisely and accurately determine spray head location and control spray head position or movement to various coordinates along positional axes. Abrupt and undesirable changes in the X, Y and Z axes, arising from system faults, changes in wall (or other surface) contour or inclement weather (e.g., strong winds, rain, etc.) are optionally detected and compensated for using the controller. For example, the system can cease painting and return the spray head carriage to a guarded position, such as within the home port upon an occurrence of a parking event. In one embodiment, a spray head for dispensing paint onto the painting surface is maintained by the spray head carriage and optionally has five jets containing various paint colors, for example cyan, magenta, yellow, black and white.

A diameter of each paint jet is determined, in part, by a distance of the spray head to the painting surface. Additionally, an internal spray partial occluder is optionally included for modifying an exit diameter of the paint jets from the spray head and can also be actuated or otherwise controlled by the controller. An overspray vacuum jacket and an overflow catch basin are optionally provided to retain any possible paint drippage.

In one embodiment, a high-resolution color video camera, optionally mounted in a short tunnel to avoid being sprayed, permits continuous observation of the painting process. If desired, a computer system or other controller directing the painting process also optically monitors the resultant application of colored paints, correcting for discrepancies. Further, the video camera or other imaging device can operate to generate an electronic representation of the surface to be painted (e.g., scanned) prior to actual painting. The computer system can operate to overlay a virtual or electronic representation of the design to be painted on to the imaged surface and display the virtual representation of a user. This, in turn, allows the user to make desired changes to the design and/or positioning of the design relative to the surface prior to actual painting.

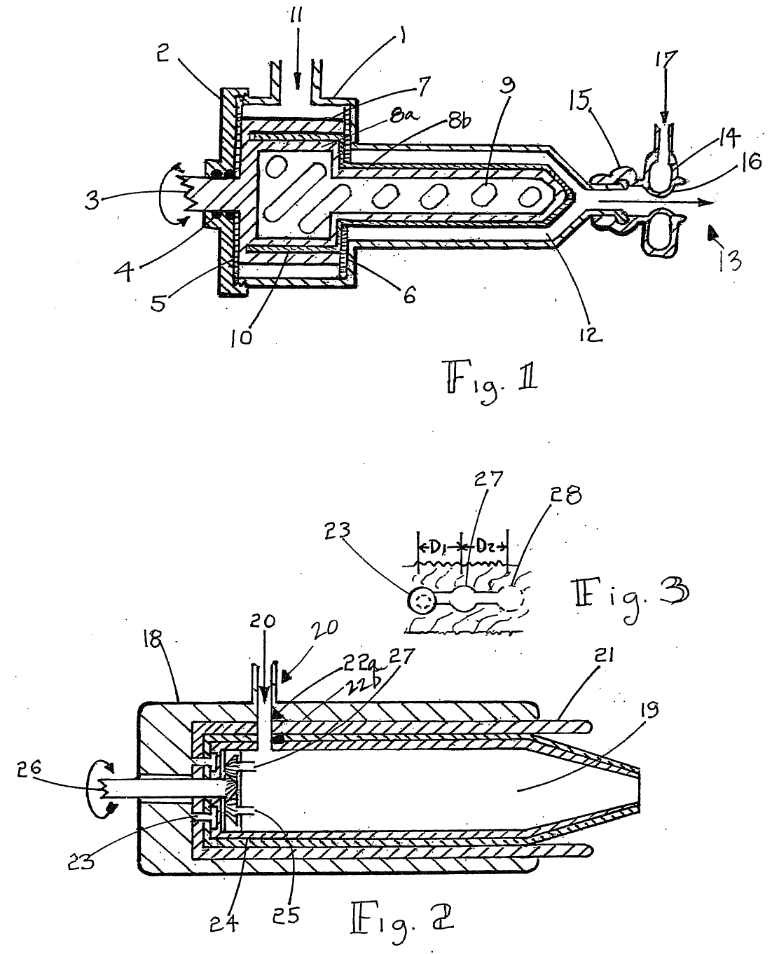

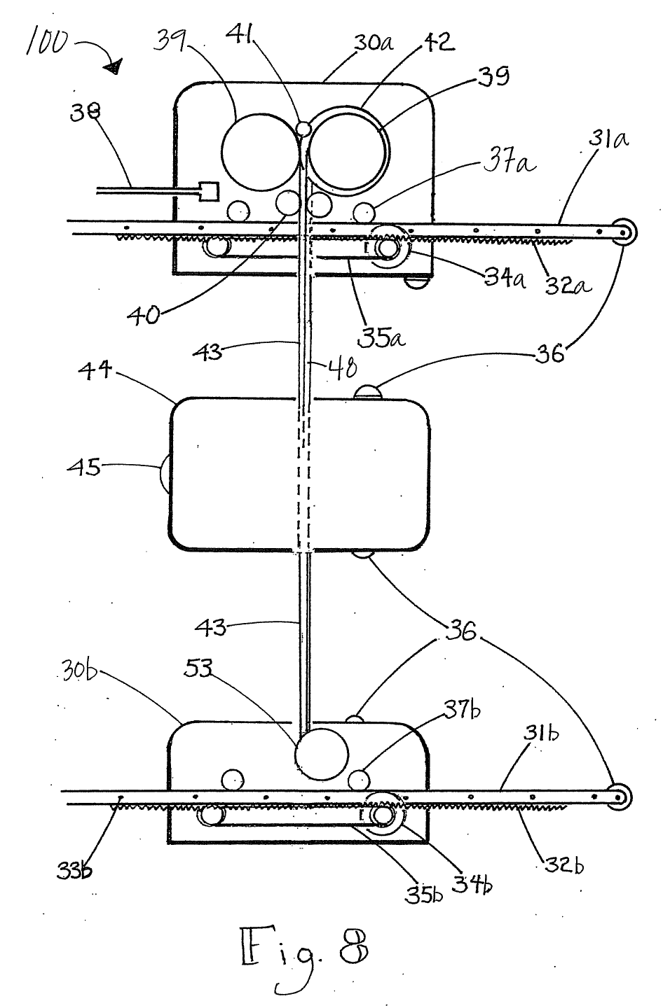

Turning now to the figures, FIGS. 1-12 illustrate components of a surface painting system 100. The system 100 includes a spray head 1 (FIG. 1), a spray head container 18 (FIG. 2), a spray head carriage 44 (FIGS. 4, 8, and 9), a track 31a (FIGS. 4, 8, and 9), a vertical positioning cable 43 (FIGS. 4 and 8), a spray head carriage 44 (FIGS. 4, 8, and 9), and a housing unit 52 (FIG. 9). As described in greater detail, one embodiment system 100 includes a second traveling control unit 30b and a second track 31b. In general terms, the system 100 is optionally used to paint various structures, for example, the system 100 is attached to a wall and brought into action to paint murals in smaller sizes (e.g., about 25 feet square), in larger sizes, (e.g., about 100 feet square), or other sizes as desired. The system 100 is attached to a surface using a variety of means, for example by using a window-cleaning platform (not shown) secured from above using parallel lifting davits. Such window-cleaning platforms, or other appropriate structures, are used for testing, maintenance and refilling of paint as desired.

FIG. 1 is a diagrammatic cross sectional plan view of the spray head 1. In general terms, the spray head 1 optionally includes a motorized rotary cutter means that whirls at a microscopic distance to outside and inside walls of a fixed filter screen to reduce to fine dimensions any paint agglomerations that might have passed through initial paint reservoir filter. In this manner, spray head clogging is reduced or eliminated.

A size of the spray head 1 is selected according to the spray head container 18 into which the spray head 1 is disposed. For example, the spray head container 18 optionally maintains a plurality of spray heads. The spray head 1 is optionally a contained capsule with a removable cap 2. Internal components of the spray head 1 are driven by a motorized shaft 3 having rotary seals 4 and low-friction thrust washers 5, 6. The motorized shaft 3 rotates a cutter 7 that is substantially tubular and hollow. The cutter 7 extends from a base portion 8a to a distal portion 8b. The cutter 7 has a plurality of slots 9 formed through the hollow cutter 7. The slots 9 are optionally substantially sharp-edged. The slots 9 are arranged along the cutter 7 to promote flow of paint from the base portion 8a to the distal portion 8b and out of the cutter 7. A filter screen 10 extends about the distal portion 8b and is interposed between walls of the base portion 8a. In one embodiment, the filter screen 10 is close fitting, sharp-edged, substantially non-moving, and follows the entire length of the cutter.

In operation, suitable paint enters via tubing 11 and passes inward through the slots 9 of the base portion 8a of the cutter 7 and the filter screen 10 in the base portion 8a. The paint then passes within the cutter 7 to the distal portion 8b of the cutter 7, out of the slots 9 of the distal portion 8b, and through the filter screen 10 into an effluent chamber 12. From the effluent chamber 12 the paint passes through an attached, spray constrictor 14 and out a distal end 13 of the spray head 1. The inflatable spray constrictor 14 is optionally held by stretching a tubular clip 15 over an end of the spray head 1. The spray constrictor 14 acts like a sphincter, the spray constrictor 14 having a more flexible circular ring 16 that under pressure 17 from a computer driven power source (not shown) changes a diameter of a passage through the ring 16 between a range of about 1 mm minimum to about 6 mm maximum, for example, to change a resultant paint spray or jet size. In turn, pressure that ejects the paint through the tube 11 and into the spray head 1 is applied to a paint reservoir containing the paint and optionally located in the spray head container 18 or the spray head carriage 44.

FIG. 2 is a diagrammatic cross sectional plan view of the spray head container 18. As referenced above, the spray head container 18 may be adapted to hold a single spray head 1 or a plurality of spray heads 1 mounted inside a chamber 19 of the spray head container 18. The self-cleaning mechanism of the spray head 1, including the cutter 7 is optionally powered via shafts 25, which are in turn powered through tapered gears meshed with a central shaft 26 attached to a controlled motor (not shown). By utilizing a central-shaft design, motorized power from the central shaft 26 can be used to power cutters 7 associated with a plurality of spray heads 1 disposed in the spray head container 18.

In order to provide paint to the tube 11 of the spray head 1, paint enters through an outer port 20 into the spray head container 18 and then passes through a first inner port 22a of an outer capsule 21 and a second inner port 22b of an inner capsule 24. The inner and outer capsules 21, 24 are capable of being rotated. For example, rotation of one or both of the capsules 21, 24 causes one or both of the first inner port 22a and the second inner port 22b to be “shut off” from the outer port 20. In this manner, one or both of the capsules 21, 24 are rotated to perform maintenance or cleaning of the spray head 1 with paint influx shut off.

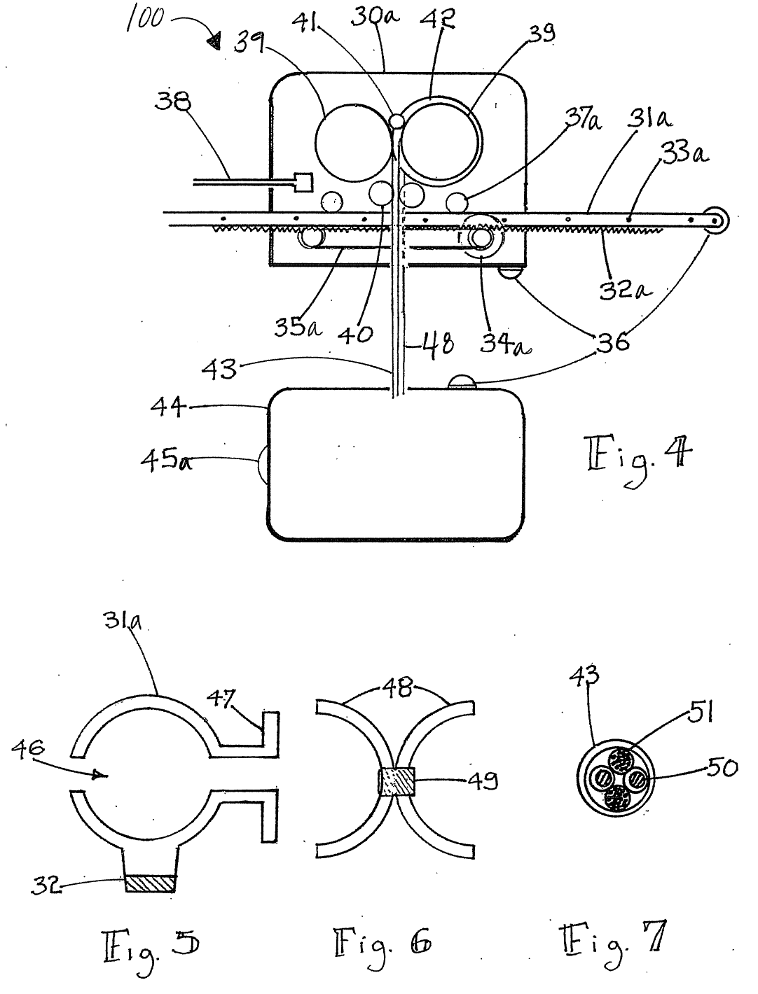

FIG. 3 is a diagrammatic plan view of an indexing pin 23 in various positions. In one embodiment, indexing pins 23 control locking/unlocking of the capsules 21, 24. In a locked position, the outer and inner capsules 21, 24 are retained by the indexing pins 23. Upon rotation to a first position D1, paint is shut off to the outer and inner capsules 21, 24 as the first and second inner ports 22a, 22b are moved out of alignment with the outer port 20. The inner capsule 24 may be further unlocked against the same indexing pins 23 to a position D2 to permit the inner capsule 24 to be removed without losing paint. Upon rotating both the inner and outer capsules 21, 24 to the position D2, both the outer and inner capsules 21, 24 are removable for maintenance, cleaning, or other operations.

FIG. 4 is a diagrammatic plan view of the first traveling control unit 30a traversing along the first track 31a and a spray head carriage 44, which maintains the spray head container 18, or a plurality thereof. In one embodiment, the first track 31a is substantially tubular in shape and is secured in a fixed position. FIG. 5 is a diagrammatic cross sectional structural view of the first track 31a having integral gear teeth 32a formed under the track 31a. The track 31a is mounted permanently if desired, such that it may be reused at any time for changing a mural image or otherwise altering a painting design, for example. In one embodiment, the first track 31a is mounted substantially horizontally, such that the first traveling control unit 30a travels horizontally on the first track 31a. Suitably formed passive upper or counterforce roller(s) 37a ride above the first track 31a to stabilize the first traveling control unit 30a as it traverses the first track 31a.

A suitable access perforation 46 in the first track 31a and a mounting surface 47 are optionally used in conjunction with an attachment bolt (not shown) to affix the first track 31a to the surface to be painted. As a point of reference, while the perforation 46 is illustrated in FIG. 5 as being an open slot, any shaped hole sufficient for protected passage and assembly of a connector (e.g., bolt) is envisioned. The first track 31a is attached to the surface to be painted using a plurality of fixtures 33, for example. The first track 31a is optionally mounted such that sagging or unintentional movement of the system 100 or portions thereof is substantially reduced or prevented.

With reference to FIG. 4, the first traveling control unit 30a includes a servo-motor 34a for driving the first traveling control unit 30a horizontally along the first track 31a. In one embodiment, the servo-motor 34a is connected to a dual gear drive belt assembly 35a including two anti-backlash geared pulleys adapted to mesh with the gear teeth 32a of the first track 31a. The pair of anti-backlash geared pulleys work in tandem to drive the first traveling control unit 30a along the first track 31a. If additional stabilization is desired, passive upper or counterforce rollers 37a optionally ride above the first track 31a to stabilize the first traveling control unit 30a on the first track 31a.

Position detectors 36, such as laser sender/receiver units and/or motion detectors or force sensors, and other types of sensors, are optionally used to assist in accurately determining a position of the first traveling control unit 30a and/or the spray head carriage 44 along the horizontal or X-axis, for example, where the first track 31a is mounted substantially horizontally. In one embodiment, the spray head carriage 44 includes position detectors 36 to determine and control horizontal and/or vertical positions of the spray head carriage 44 and the spray head unit(s) 1 maintained by the spray head carriage 44. In turn, the first track 31a includes position detectors 36 at one or both ends of the first track 31a to assist in determining horizontal and/or vertical position of the spray head unit(s) 1. Irregularities in wall texture or structure of the surface to be painted are optionally accounted for in some embodiments, for example using the position detectors 36. In particular, irregularities in the surface to be painted optionally are accounted for by tracking a distance between the spray head carriage 44 and the surface to be painted, also referred to as Z-axis distance.

Where the first track 31a is mounted horizontally, the spray head carriage 44 is suspended from the first traveling control unit 30a. For smaller murals (e.g., about 25 feet in width or height) the spray head carriage 44 is optionally suspended from the first traveling control unit 30a without use of additional traveling control units. A dual tape structure 48 is optionally used to suspend the spray head carriage 44 from the first traveling control unit 30a to provide a flexible, retractable, yet stiff structure to control vertical positioning of spray head carriage 44.

FIG. 6 is a diagrammatic cross sectional view of the dual tape structure 48 including flexible tapes having friction fitting male/female prominences/perforations 49 holding opposing tapes firmly together. In one embodiment, the dual tape structure 48 includes a pair of steel ribbons formed like measuring tapes and secured back-to-back with the friction fitting male/female prominences 49 holding the opposing tapes firmly together. In one embodiment, the back-to-back dual tape configuration provides the horizontal rigidity required to maintain precision of the spray head vertical position.

With reference again to FIG. 4, in one embodiment each of the flexible steel tapes of the dual tape structure 48 are maintained separately on a respective drum 39. The formed flexible steel tapes are both let out and pulled in on the drums 39 under precise servo control. During let out, or extension, the flexible steel tapes are pressed together by rollers 40 to bond the two tapes together, back-to-back to form the dual tape structure 48 as an extendable, rigid, and vertical member. On upward return of the bonded steel tapes, or pulling in, they are separated by an idler roller 41 before returning to their respective drums 39.

Additionally, or alternatively, a vertical positioning cable 43 is employed to assist in vertical movement of the spray head carriage 44. The cable 43 is optionally a vertical traction cable adapted to act against an intrinsic weight of the spray head carriage 44. In one embodiment, the cable 43 is a composite vertical traction and insulated cable for electrical supply, for example. The first traveling control unit 30a includes a cable drum 42 that is servo controlled for both pulling in and letting out the cable 43.

FIG. 7 is a diagrammatic cross sectional view of one embodiment of the cable 43 that is a composite traction and electrical cable used to suspend the spray head carriage 44. High frequency signals are optionally transmitted on these wires, from and to a controller or other control circuits or processors (not shown). In one embodiment, electrically insulated power wires 50 provide power to servo-motors, position detectors, and other components of the system 100. In one embodiment, the cable 43 includes zero elastic spun stainless steel cables 51 to provide the suspension and vertical position control of the spray head container unit 44.

With reference again to FIG. 4, the first traveling control unit 30a also optionally includes a horizontal pulling cable 38 that attaches the first traveling control unit 30a to a motor on the housing unit 52 (FIG. 9). In general terms, the housing unit motor on the housing unit 52 provides a pulling action on the first traveling control unit 30a to maintain counter-tension against the servo motor 34a and associated linked gear drive.

In one embodiment, precise horizontal position feedback employs the position detectors 36 and an associated control computer (not shown). The spray head container unit 44 is optionally calibrated, initially positioned, and/or position monitored utilizing the position detectors 36. The spray head carriage 44, when loaded with the spray head container(s) 18 and associated spray head(s) 1 and paint weigh between about 25 and 50 pounds. In particular, weight of the spray head carriage 44 can provide additional assistance in stabilizing and/or ensuring accurate positioning of the container unit 44.

The spray head carriage 44 also includes a convex portion of a multiple port, paint filling coupling valve 45a. The convex valve portion 45a is described in greater detail below. Paint reservoirs, servomotors for pressurizing the reservoirs for paint delivery to the spray heads and servo drive motors are not shown but should be understood by those of skill in the art with reference to this description and the figures. When a primer is used, the entire spray head 1 or spray head container 18 is demounted and replaced with an essentially monochrome sprayer set-up. Following this, a final multicolor unit may be substituted for painting the mural or other painting design or image.

Both horizontal (X-axis) and vertical (Y-axis) positions of the spray head carriage 44 and the one or more spray heads 1 maintained therein are controllable to an accuracy of ±2 mm, for example. The entire spray head carriage 44 is detachable and replaceable as needed for maintenance. For example, spray head(s) 1, reservoirs (not shown), spray head containers 18, or the entire spray head carriage 44 may be removed or exchanged for multi-head rapid primer painting of a large wall or other surface to be painted.

FIG. 8 is a diagrammatic plan view of an embodiment surface painting system 100 according to principles of the present disclosure including a second traveling control unit 30b traversing a second track 31b. The second traveling control unit 30b is optionally provided to add additional support and/or control for painting larger murals (e.g., about 100 feet in height or larger), although larger murals are optionally painted with embodiments of the system 100 not including the second traveling control unit 30b and/or associated second track 31b. In combination, the first and second traveling control units 30a, 30b optionally employ a tight wire and loop method to raise and lower the spray head carriage 44. In one embodiment, the second traveling control unit 30b is servo locked with the first traveling control unit 30a. As referenced above, relative positions of the second traveling control unit 30b are also optionally ascertained and controlled using position detectors 36.

The first traveling control unit 30a is shown positioned on the first track 31a. The drums 39 maintaining portions of the dual tape structure 48, the horizontal pulling cable 38, the rollers 40 for tape bonding, and the roller 41 for tape separation are shown. The cable drum 42 is shown along with the vertical positioning cable 43. However, this cable 43 now not only attaches to the spray head container unit 44 but also is looped around a servo controlled lower drive pulley 53 to apply tension and pull the spray head container unit 44 into the required vertical positions in combination with the cable drum 42. The expected vertical and horizontal accuracies should be about ±2 mm, for example. The dual tape structure 38 is optionally removed with the cable 38 entirely controlling vertical position of the spray head carriage 44 if desired.

The second traveling control unit 30b rides on the second track 31b, which is optionally substantially similar in shape and form to the first track 31a. For example, the second track 31b is substantially tubular and includes gear teeth 32b, in one embodiment. The second track 31b is optionally attached to the surface to be painted in a similar manner to the first track 31a. The second traveling control unit 30b includes a dual gear drive belt assembly 35b drive by a servo-motor 34b. In one embodiment, the servo-motors 34a, 34b of the first and second traveling control units 30a, 30b, respectively, are optionally controlled in tandem or otherwise linked such that the position of the first and second traveling units 30a, 30b are precisely controlled and aligned with a controller or other fully automated or semi-automated control system. This precise correlation is measured and controlled through the position detectors 36, for example. In one embodiment, the servo controlled lower drive pulley 53 facilitates accurate maintenance of both the vertical position of the spray head carriage 44 and the tension applied to the vertical positioning cable 43.

FIG. 9 is a diagrammatic plan view of the housing unit 52. In one embodiment, the housing unit 52 serves as a master robotic “home” or “parking garage” for the first traveling control unit 30a and/or the spray head carriage 44 when positioned in the housing unit 52 in a storage, maintenance, or otherwise “parked” position. In one embodiment, paint is replenished and maintenance performed with the first traveling control unit 30a and/or the spray head carriage 44 in the parked position by a technician supported on an additional “window cleaner's” platform, for example. In the event of unexpected problems or inclement weather, the spray head carriage 44 and/or the first traveling control unit 30a optionally automatically return to be parked and protected in the housing unit 52. Upon such parking, one or more cables or other connectors attached to the second traveling control unit 30b optionally pass through a gap (not shown) in a bottom of the housing unit 52, with the second traveling control unit 30b remaining attached to the second track 31b.

The position detectors 36 are shown now in an optional nestled position upon parking the first traveling control unit 30a and the spray head carriage 44 together. The horizontal traction or pulling cable 38 is shown connected to a servo motor 28 of the housing unit 52. As referenced above, the horizontal pulling cable 38 is attached to the first traveling control unit 30a to provide a pulling action on the first traveling control unit 30a to maintain counter-tension against the servo motor 34a. The convex valve portion 45a of the first traveling control unit 30a is also shown.

In one embodiment, the housing 52 includes an access door 54 with a lock 55 for accessing removable/refillable paint containers 56. The housing 52 also optionally includes a multi-tube paint roller pump 57 as detailed below. In one embodiment, visible status lights optionally indicate functions and requirements for maintenance. This data is also optionally transmitted wirelessly to a responsible maintenance technician, the paint contractor's central office, and/or any other remote location as desired.

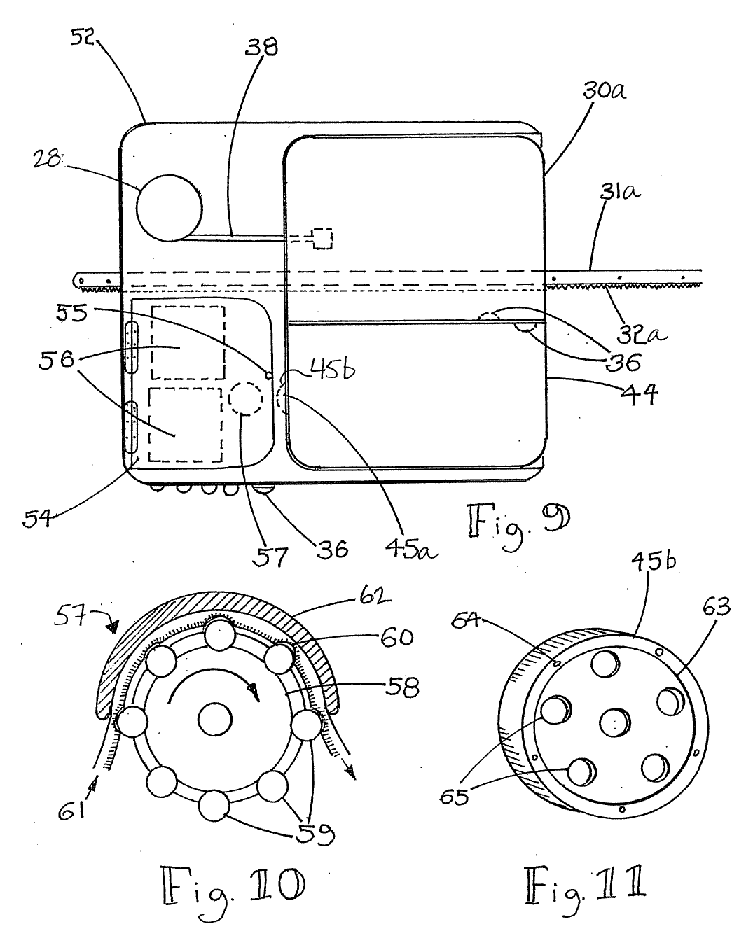

FIG. 10 is a diagrammatic plan view of the multi-tube paint roller pump 57. A pump housing 62 serves as a counter plate for a servo motor driven, shaft mounted, and circular plate 58 turning a plurality of rollers 59 that compress a tube 60 to draw paint into the tube 60 at an entry point 61 from reservoirs (not shown) and dispense one or more paints from the tube 60 to the decoupling concave valve portion 45b and ultimately to spray head paint reservoirs (not shown) inside the spray head carriage 44. Operation of the roller pump 57 is also optionally under servo control and can be operated by the controller according to paint reservoir needs and applied pressures. Each of the plurality of rollers 59 is suitably mounted for rotational freedom on the circular plate 58. A plurality of parallel circular plates (not shown) similar to the circular plate 58 are optionally provided, each plate pumping a desired paint through a corresponding tube to the coupling concave valve portion 45b. In one embodiment, the plurality of parallel circular plates is driven by a common drive shaft (not shown) through individual magnetic clutches (not shown) mounted on the shaft. Each of the plurality of plates is optionally engaged individually using the corresponding magnetic clutch, for example via computer control, for dispensing a specific volume of a particular paint.

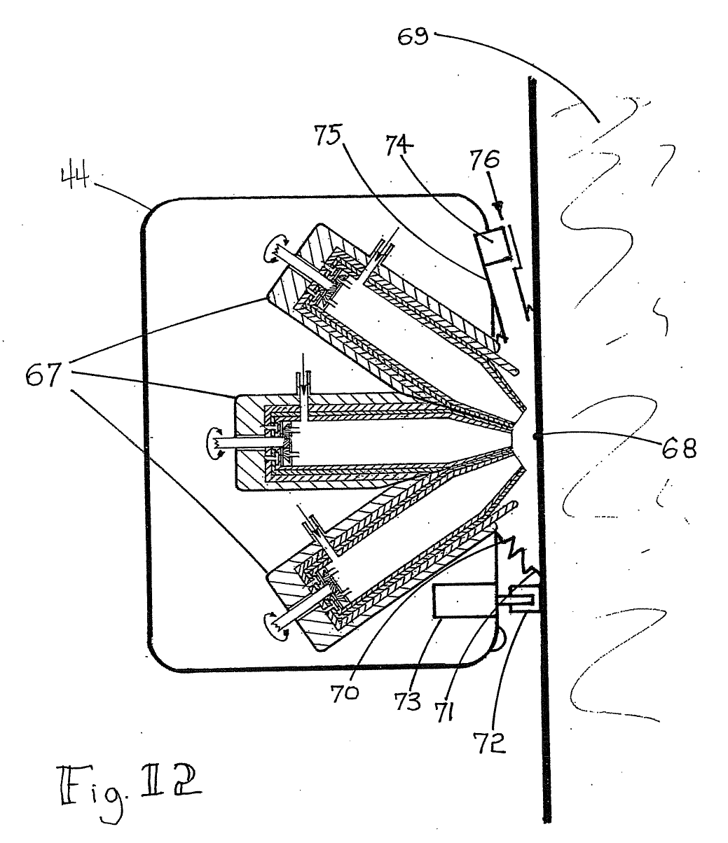

FIG. 11 is a perspective view of the paint filling concave valve portion 45b. The valve portions 45a, 45b is generally used to provide temporary, fluid communication between the pump 57 and paint reservoirs maintained on the spray head carriage 44. The concave valve portion 45b includes a rotary valve assembly 63 having a relatively precise concave surface that indexes and locks together with the convex valve portion 45a located attached to the spray head carriage 44. In particular, the rotary valve assembly 63 and convex valve portion 45a mate upon “parking,” or otherwise moving the spray head carriage 44 into the housing unit 52. Indexing and locking pins 64 assure a firm, precise alignment of paint valve portions 45a, 45b before the paint roller pump begins to function and replenishing paint delivery to the spray head container reservoirs is permitted. The servo controlled, rotary actuator locking the convex-concave valve portions 45a, 45b together are not shown, but can take a variety of forms including those known to one of ordinary skill in the art upon reading this specification and reviewing the figures. The function of replenishing the paint supply is also optionally under computer control and is somewhat similar to “in-flight refueling.”

FIG. 12 is a diagrammatic side view of the spray head carriage 44 having a plurality of spray head containers 67. Each of the plurality of spray head containers 67 is optionally substantially similar to the spray head container 18 (FIG. 2). The plurality of spray head containers 67 are positioned to define a common point or focal point 68 on a surface 69 to be painted. Though the spray head containers 67 may be aligned as shown, having a confluent focus point, the spray head containers 67 are also optionally mounted in a vertical arrangement, like inkjet printer heads. The spray head containers 67 may also be mounted horizontally, or otherwise as best indicated for a particular painting operation. The configuration of heads may be altered to being used for single or multiple pass painting methods, similar to those used in X-Y or inkjet printers, for example.

An optional bellows skirt 70 under vacuum pressure acts as a paint overspray scavenger. In other words, the bellows skirt 70 is used to prevent fly-away paint. In one embodiment, the bellows skirt 70 draws the spray head carriage 44 closer to the wall. At a lowest rim of the bellows skirt 70 there is a small drip collecting reservoir 71. Actual distance of the spray head carriage 44, and in particular, the spray head containers 67 to surface 69, is important to spray jet diameter and spray density. In one embodiment, distance from the surface 69, or the Z-axis distance, is set by using a suitable roller 72 attached to a servo controlled linear actuator 73.

In one embodiment, a remote viewing video camera 74 is mounted to the spray head carriage 44 and permits scanning of the surface to be painted as well as visual control of spray head activity. To prevent paint clouding of the camera 74, the camera 74 is optionally mounted in a short tunnel 75 through which filtered air is drawn in through a side port 76 towards the overspray bellows skirt 70. The video camera 74 is optionally connected to the controller for monitoring or surface scanning.

For one skilled in the art, other mounting, carrier, deployment, reference measuring and servo control designs may be substituted without changing the intent and performance of the disclosure.

In one embodiment method of painting a mural with the system 100, the surface to be painted is scanned or photographed using a high-resolution digital camera, and an image is fed into a painting controller, such as a computer or multiple computers. Locations of wall variations are optionally identified by the controller and entered into a database. Then an artist, a client, the controller, or other suitable decision-maker, reviews various artistic choices, determines the exact image to be painted, taking into account the wall variations as desired. Various additions, subtractions, distortions, corrections, colors and forms are computer screen manipulated using a high-resolution software paint program, for example. Regardless, a final image is optionally input to the controller. The controller optionally automatically generates a painting plan for painting the image. The painting plan includes information relating to a path or trajectory of the spray head carriage 44, paints needed including amount and type, job timing including time to completion, positioning details for the first and/or second tracks 31a, 31b, and other relevant information. A visual representation of the intended design overlayed to the imaged surface can be displayed to a user, and desired alterations to the design and/or location (relative to the surface to be painted) can be implemented prior to actual painting.

In one embodiment, the first track 31a is attached to the building, a power source is connected to the housing unit 52 and under observation by the controller or an operator the details of the wall and it variations are scanned using the unloaded spray head carriage 44, for example utilizing digital imaging, laser sensing, or other position detecting means. In one embodiment, a computer program, with the anticipated mural in memory, predicts a quantity of paint to be applied, a pattern of head deployment to be used, and a timing schedule for the job, or other relevant information. Variations in the schedule are optionally entered by the technician or monitored by the controller with the painting plan modified manually or automatically according to deviations from the painting plan. For example, the painting design is optionally monitored by the controller using imaging techniques or using the position detectors 36. In the case of rain or inclement weather, the system 100 optionally automatically shuts down and the carriages are parked in the housing unit 52.

In one embodiment, the first paint application is a primer. In this case, for a large mural, all spray heads 1 in a container unit 18 may be mounted to use the same primer paint. As the spray head carriage 44 depletes its paint supply, or its paints reservoirs, this information is communicated visually by indicator lights on the housing unit 52 and/or wirelessly to the controller. The spray head carriage 44 robotically returns to its cage home for paint replenishing. While in such a parked position using additional means not shown, various maintenance functions might be performed such as testing of the spray heads 1, cleaning and spray size adjustment of the spray constrictors 14, and others.

In one embodiment, upon encountering problems, upon the additional needing of one or more of the paints to be replenished, or at the completion of the job, for example, the spray head carriage 44 and first traveling control unit 30a merge and return to the housing unit 52 for service or removal. At termination of the job the first and second tracks 31a, 31b optionally remain attached to the surface to be painted for potential reuse in painting other designs or images.

Various paints are optionally used with the system 100. However, paints ordinarily are moderately quick drying, non-toxic and usually sun-fast acrylics. However, certain special applications might dictate the use of oil-based paints, paint with pigments that fade over time or fully water soluble paint that can be washed away after a predetermined time or after a limited contract period for image appearance, such as during political campaigns, for special holiday events, special product sales events or temporary messages of importance or portraits for special recognition.

In light of the above, the disclosure has the ability to survey surfaces to be painted, accept appropriate designs, sizes and colors that will be used, predict quantities of paint and time required in the painting of large murals on the walls of building surfaces, indoor and outdoor, using an automatic, servo feedback, computer controlled, precise and rapid system, with human surveillance and manual override as desired. The system 100 is self-correcting and maintaining with the status of its needs and demands communicated wirelessly to a control computer and/or human technician-operator. The system 100 and method is extremely precise, rapid and flexible, and under control by the programmed computer or human operator at all times. The system 100 can be used on irregular surfaces and can account for windows, doorways and protrusions with corrective actions in order to proceed, with or without additional human interaction. In one embodiment, only minimal training is required of the operator.

Separate artistic skills are used in preparing the images to be painted employing themes as desired by the particular client. The painting contractor or others using the system 100 attach the first track 31a and perhaps second track 31b permanently, semi-permanently or temporarily to the surface to be painted, arrange for electrical power supply installation and calibrate the housing unit 52 and paint supply. The wall is scanned for details and the system 100 is tested before beginning the program to paint the wall. Further surveillance is indicated by visible lights and the computer program; urgent situations are communicated to a technician, the installing company office, the controller or other decision-maker for corrective action. The entire process of painting is nearly or completely automatic and self-correcting. Very large murals may be painted with speed and accuracy. A variety of paint media may be used for special purposes, as indicated above.

A standard, highly detailed tromphe l'oele or classical “tricking of the eye” mural that would require highly skilled artists perhaps far more than a month or two to paint by hand could be painted using the system 100 in a weekend, weather permitting. Embodiments of the present disclosure provide for high-resolution painting of a wide variety of artistic subjects, portraits, three dimensional representations or scenes of nature, the ocean, mountains, or unusual formations like the Grand Canyon. Such images would often otherwise be prohibitive in time, talent, detail and money needed if painted by hand. If the method does not suffice, manual painting or final touch-up of the images may be employed.

The automatic, computer controlled painting of large wall murals reduces or is devoid of any undesirable side effect such as contamination of the environment, dripping paint or paint overspray clouds onto surfaces or persons below. The attainment of magnificent permanent or temporary murals is optionally made rapid and complete. Multicolor spray heads 1 of the system 100 do not require multiple passes in order to apply all five colors, although separate passes for white or black may be desired for contrast purposes or multiple passes may be needed to cover previously painted designs, for example. With the system 100 disclosed herein, the technician or controller advantageously can adjust the majority of system parameters during the wall mapping, planning and painting phases of painting plan generation. The spray heads 1 can be constructed of metal, polymer or ceramic and attached to the spray heads 1 and carrier 18 in a variety of ways. Preferred means to deliver the paint by liquid jet or atomization spray can be selected during a single or later pass of the spray heads 1.

Although specific embodiments have been illustrated and described herein, it will be appreciated by those of ordinary skill in the art that a variety of alternate and/or equivalent implementations may be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

What is claimed is:

1. A surface painting system comprising:
a first track adapted to be secured relative to a surface to be painted and extend along the surface to be painted;
a first traveling control unit mounted on the first track and adapted to traverse the track;
a spray head carriage maintained by the first traveling control unit with a connector extending between the first traveling control unit and the spray head carriage;
a spray head housed by the spray head carriage, the spray head adapted to emit a spray of paint for painting the surface to be painted; and
an actuator adapted for extending or retracting the connector to move the spray head carriage toward and away from the first traveling control unit.

2. The surface painting system of claim 1, further comprising:
a second track secured to the surface to be painted; and
a second traveling control unit mounted on the second track and adapted to traverse the second track;
wherein the spray head carriage is maintained by the second traveling control unit with a connector for moving the spray head carriage toward and away from the second traveling control unit.

3. The surface painting system of claim 1, wherein the connector is a dual tape structure.

4. The surface painting system of claim 1, wherein the connector comprises:
a support wire adapted to maintain at least about 25 lbs; and
an electrically insulated wire.

5. The surface painting system of claim 1, wherein the surface to be painted is at least about 25 feet in width.

6. The surface painting system of claim 1, wherein the spray head defines a paint path through the spray head, and further wherein the spray head includes a rotating blade disposed in the paint path for reducing spray head clogging.

7. The surface painting system of claim 1, further comprising:
a controller in communication with the traveling control unit, the actuator, and the spray head carriage, the controller adapted to execute a painting plan for a design to be painted.

8. The surface painting system of claim 7, further comprising:
a plurality of position sensors adapted to communicate information relating to a position of the spray head carriage to the controller.

9. The surface painting system of claim 1, wherein the spray head carriage includes a paint reservoir for feeding paint to the spray head, the system further comprising:
a housing unit secured to the first track, the housing unit adapted to receive the spray head carriage and refill the paint reservoir.

10. The surface painting system of claim 1, wherein the first track extends substantially horizontally, and further wherein the actuator is adapted to move the spray head carriage substantially vertically relative to the first traveling control unit.

11. The surface painting system of claim 1, further comprising:
an imaging device for capturing an image of the surface before and during painting.

12. A method of painting a surface comprising:
securing a first track relative to a surface to be painted;
mounting a first traveling control unit to the first track;
suspending a spray head from the first traveling control unit and in front of the surface to be painted;
moving the spray head relative to the surface to be painted by moving the first traveling control unit along the first track to move the spray head along a first painting axis and moving the spray head relative to the first traveling control unit along a second painting axis; and
executing a painting plan for a design to be painted by emitting a spray of paint from the spray head at various coordinates onto the surface to be painted.

13. The method of painting a surface of claim 12, wherein the painting plan is computer generated and execution of the painting plan is performed automatically.

14. The method of painting a surface of claim 12, wherein the design to be painted is at least about 25 feet square.

15. The method of painting a surface of claim 12, further comprising:
taking an image of the surface to be painted;
inputting the image of the surface to a controller;
generating a painting plan with the controller according to the image of the surface; and
executing the painting plan with the controller.

16. The method of painting a surface of claim 12, further comprising:
inputting the design to be painted into a controller; and
automatically generating the painting plan to be executed.

17. The method of claim 16, wherein the painting plan includes information relating to a plurality of paint head coordinates, an amount of paint for painting the design, and painting time.

18. The method of claim 16, further comprising:
automatically monitoring progress of the painting plan for deviations from the painting plan; and
automatically adjusting the painting plan to account for the deviations from the painting plan.

19. The method of claim 12, further comprising:
capturing an electronic image of the surface prior to executing the painting plan;
overlaying an image of an intended design to the captured image of the surface; and
generating a revised painting plan based upon an evaluation of the overlayed image.
